(19) United States
(12) Patent Application Publication
(10) Pub. No.: US 2013/0063040 A1
(43) Pub. Date: Mar. 14, 2013

(54) LIGHT-EMITTING COMPONENT DRIVING CIRCUIT AND RELATED PIXEL CIRCUIT AND APPLICATIONS

(71) Applicants: Chih-Hung Huang, Taichung City (TW); Wen-Chun Wang, Taichung City (TW); Wen-Tui Liao, Taichung City (TW)

(72) Inventors: Chih-Hung Huang, Taichung City (TW); Wen-Chun Wang, Taichung City (TW); Wen-Tui Liao, Taichung City (TW)

(73) Assignee: WINTEK CORPORATION, Taichung City (TW)

(21) Appl. No.: 13/609,262

(22) Filed: Sep. 11, 2012

(30) Foreign Application Priority Data
Sep. 13, 2011 (TW) 100132791
Jul. 20, 2012 (TW) 101126319

(51) Int. Cl. H05B 37/02

(52) U.S. Cl. 315/232

(57) ABSTRACT

A pixel circuit related to an organic light-emitting diode (OLED) is provided. When signals having appropriate operating waveforms are supplied, the circuit configuration (6T1C) of the pixel circuit keeps a current flowing through an OLED unchanged when the Vth shift of the TFT for driving the OLED changes and eases the impact of a power supply voltage Vdd on the current. Thereby, the luminance uniformity of an OLED display adopting the OLED pixel circuit is greatly improved.

### CROSS-REFERENCE TO RELATED APPLICATION

This application claims the priority benefits of Taiwan application serial no. 100132791, filed on Sep. 13, 2011, and Taiwan application serial no. 101126319, filed on Jul. 20, 2012. The entirety of each of the above-mentioned patent applications is hereby incorporated by reference herein and made a part of specification.

### BACKGROUND OF THE INVENTION

1. Field of the Invention

The invention generally relates to a flat panel display technique, and more particularly, to a driving circuit of a self-emissive light-emitting component (for example, an organic light-emitting diode (OLED), but not limited thereto) and related pixel circuit and applications.

2. Description of Related Art

Semiconductor and display technologies have been quickly developed along with the swift advance of our multimedia society. Regarding displays, active matrix organic light emitting diode (AMOLED) display is one of the most adaptable displays in today's multimedia age thanks to its many characteristics such as unlimited viewing angle, low fabrication cost, high response speed (over 100 times of that of liquid crystal display (LCD)), low power consumption, self-emission, applicability to DC driving of portable machines, large working temperature range, light weight, and small and slim size in accordance to any hardware equipment. Thus, AMOLED display is very potential and may replace LCD as a next-generation flat panel display.

Presently, an AMOLED display panel may be fabricated through a low-temperature polysilicon (LTPS) thin film transistor (TFT) fabrication process or an amorphous silicon (a-Si) TFT fabrication process. The LTPS TFT fabrication process includes relatively more photomask processes therefore offers a high cost. Thus, presently, the LTPS TFT fabrication process is usually used for manufacturing small-sized and medium-sized display panels, while the a-Si TFT fabrication process is usually used for manufacturing large-sized display panels.

Generally speaking, in an AMOLED display panel fabricated through the LTPS TFT fabrication process, the TFTs in a pixel circuit may be P-type TFTs or N-type TFTs. Because P-type TFTs offer a very good driving capability in the conduction of positive voltages, most existing AMOLED display panels are implemented by using P-type TFTs. However, if an organic light-emitting diode (OLED) pixel circuit is implemented by using P-type TFTs, the current flowing through the OLED changes not only with the impact of IR drop on a power supply voltage Vdd but also with the Vth shift of the TFT for driving the OLED. As a result, the luminance uniformity of an OLED display is impaired.

### SUMMARY OF THE INVENTION

Accordingly, to improve the luminance uniformity of an organic light-emitting diode (OLED) display, an exemplary embodiment of the invention provides a light-emitting component driving circuit. The light-emitting component driving circuit includes a power unit, a driving unit, a data storage unit, and a light-emitting control unit. The power unit receives a power supply voltage and in a light enable phase, conducts the power supply voltage in response to a light enable signal. The driving unit is coupled between the power unit and a light-emitting component and includes a driving transistor. In the light enable phase, the driving unit controls a driving current flowing through the light-emitting component.

The data storage unit includes a storage capacitor coupled between the driving transistor and a reference potential. In a data-writing phase, the data storage unit stores a data voltage and a threshold voltage of the driving transistor through the storage capacitor in response to a write scan signal. The light-emitting control unit is coupled between the driving unit and the light-emitting component. In the light enable phase, the light-emitting control unit conducts the driving current from the driving unit to the light-emitting component in response to the light enable signal. In the light enable phase, the driving unit generates the driving current flowing through the light-emitting component in response to a cross-voltage of the storage capacitor, and the driving current flowing through the light-emitting component is not affected by the threshold voltage of the driving transistor.

In an exemplary embodiment of the invention, the data voltage is related to the power supply voltage. Accordingly, in the light enable phase, the impact of the power supply voltage on the driving current flowing through the light-emitting component is effectively reduced/mitigated/released in response to the data voltage related to the power supply voltage.

In an exemplary embodiment of the invention, the power unit includes a power conduction transistor. The source of the power conduction transistor receives the power supply voltage, and the gate of the power conduction transistor receives the light enable signal. In addition, the source of the driving transistor is coupled to the drain of the power conduction transistor, and the gate of the driving transistor is coupled to the first end of the storage capacitor. Moreover, the second end of the storage capacitor is coupled to the reference potential.

In an exemplary embodiment of the invention, the data storage unit further includes a writing transistor and a collection transistor. The gate of the writing transistor receives the write scan signal, the source of the writing transistor receives the data voltage, and the drain of the writing transistor is coupled to the drain of the power conduction transistor and the source of the driving transistor. The gate of the collection transistor receives the write scan signal, the source of the collection transistor is coupled to the gate of the driving transistor and the first end of the storage capacitor, and the drain of the collection transistor is coupled to the drain of the driving transistor.

In an exemplary embodiment of the invention, the data storage unit further initializes the storage capacitor in response to a reset scan signal in a reset phase. Thus, the data storage unit further includes a reset transistor. The gate and the source of the reset transistor are coupled with each other for receiving the reset scan signal, and the drain of the reset transistor is coupled to the gate of the driving transistor, the source of the collection transistor, and the first end of the storage capacitor.

In an exemplary embodiment of the invention, the light-emitting control unit includes a light-emitting control transistor. The gate of the light-emitting control transistor receives the light enable signal, and the source of the light-emitting control transistor is coupled to the drains of the driving transistor and the collection transistor.

In an exemplary embodiment of the invention, the first terminal of the light-emitting component is coupled to the drain of the light-emitting control transistor, and the second terminal of the light-emitting component is coupled to the reference potential.

In an exemplary embodiment of the invention, the driving transistor, the power conduction transistor, the writing transistor, the collection transistor, the reset transistor, and the light-emitting control transistor are all P-type transistors.

In an exemplary embodiment of the invention, the light-emitting component is an OLED, the first terminal of the light-emitting component is the anode of the OLED, and the second terminal of the light-emitting component is the cathode of the OLED. Thus, the light-emitting component driving circuit is an OLED driving circuit, and the OLED driving circuit sequentially enters the reset phase, the data-writing phase, and the light enable phase.

In an exemplary embodiment of the invention, in the reset phase, the reset scan signal is enabled, and the write scan signal and the light enable signal are disabled. In the data-writing phase, the write scan signal is enabled, and the reset scan signal and the light enable signal are disabled. In the light enable phase, the light enable signal is enabled, and the reset scan signal and the write scan signal are disabled.

Another exemplary embodiment of the invention provides a pixel circuit having the light-emitting component driving circuit described above, and the pixel circuit is an OLED pixel circuit.

Yet another exemplary embodiment of the invention provides an OLED display panel having the OLED pixel circuit mentioned above.

Still another exemplary embodiment of the invention provides an OLED display having the OLED display panel mentioned above.

As described above, the invention provides an OLED-related pixel circuit. When signals having appropriate operating waveforms are supplied, the circuit configuration (6T1C) of the pixel circuit keeps a current flowing through an OLED unchanged when the Vth shift of the TFT for driving the OLED changes and eases the impact of the power supply voltage Vdd on the current. Thereby, the luminance uniformity of an OLED display adopting the OLED pixel circuit is greatly improved.

These and other exemplary embodiments, features, aspects, and advantages of the invention will be described and become more apparent from the detailed description of exemplary embodiments when read in conjunction with accompanying drawings.

However, it should be understood that both foregoing general description and following detailed description are exemplary and are not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an organic light-emitting diode (OLED) pixel circuit 10 according to an exemplary embodiment of the invention.

FIG. 2 is a circuit diagram of the OLED pixel circuit 10 in FIG. 1.

FIG. 3 illustrates an operation waveform of the OLED pixel circuit 10 in FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

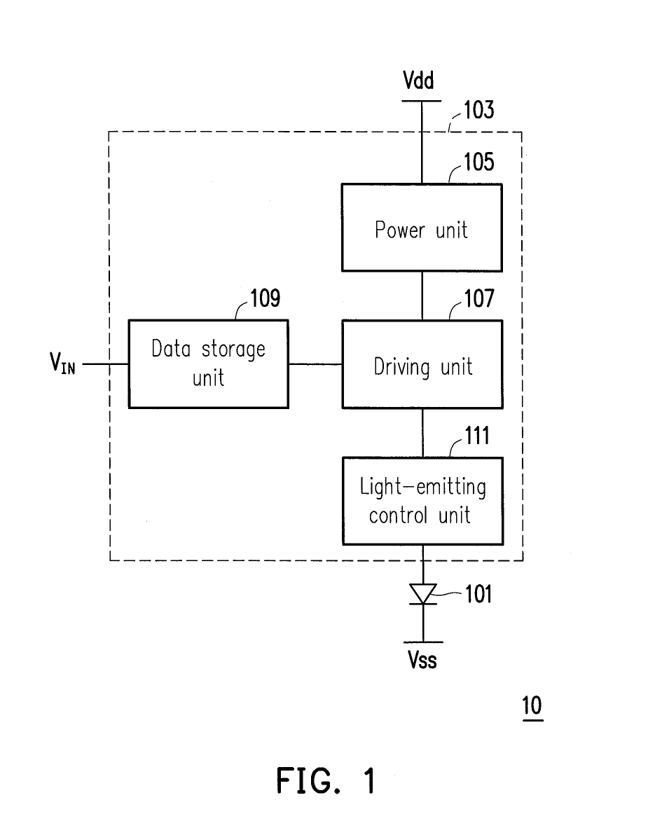

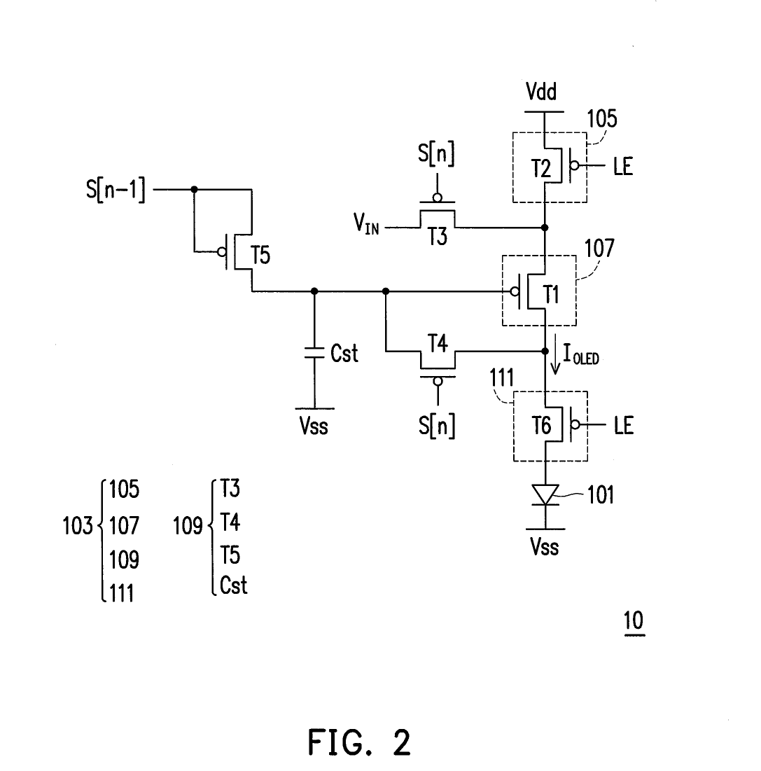

FIG. 1 is a diagram of a pixel circuit 10 according to an exemplary embodiment of the invention, and FIG. 2 is a circuit diagram of the pixel circuit 10 in FIG. 1. Referring to both FIG. 1 and FIG. 2, in the present exemplary embodiment, the pixel circuit 10 includes a light-emitting component (for example, an organic light-emitting diode (OLED) 101, but not limited thereto, and accordingly the pixel circuit 10 can be considered as an OLED pixel circuit) and a light-emitting component driving circuit 103. The light-emitting component driving circuit 103 includes a power unit 105, a driving unit 107, a data storage unit 109, and a light-emitting control unit 111.

In the present exemplary embodiment, the power unit 105 receives a power supply voltage Vdd, and in a light enable phase, conducts the power supply voltage Vdd in response to a light enable signal LE.

The driving unit 107 is coupled between the power supply voltage Vdd and the OLED (i.e., light-emitting component) 101, and includes a driving transistor T1. Besides, in the light enable phase, the driving unit 107 controls a driving current I_{OLED} flowing through the OLED (i.e., light-emitting component) 101.

The data storage unit 109 includes a storage capacitor Cst coupled between the driving transistor T1 and a reference potential Vss. In a data-writing phase, the data storage unit 109 stores a data voltage V_{IN} and a threshold voltage Vₜₕ(T1) of the driving transistor T1 through the storage capacitor Cst in response to a write scan signal S[n]. Herein the write scan signal S[n] is a signal on a current scan line and supplied by an n-th stage of gate driving circuit, but the invention is not limited thereto.

In a reset phase, the data storage unit 109 further initializes/resets the storage capacitor Cst in response to a reset scan signal S[n−1]. The reset scan signal S[n−1] is a signal on a previous scan line and supplied by a (n−1)-th stage of gate driving circuit, but the invention is not limited thereto.

The light-emitting control unit 111 is coupled between the driving unit 107 and the OLED 101. Besides, in the light enable phase, the light-emitting control unit 111 conducts the driving current I_{OLED} from the driving unit 107 to the OLED 101 in response to the light enable signal LE.

In the present exemplary embodiment, the driving unit 107 generates the driving current I_{OLED} flowing through the OLED 101 in response to the cross-voltage of the storage capacitor Cst in the light enable phase, and the driving current I_{OLED} flowing through the OLED 101 is completely unaffected by the threshold voltage Vₜₕ(T1) of the driving transistor T1.

Additionally, if the data voltage V_{IN} stored in the data-writing phase is related to the power supply voltage Vdd (for example, the data voltage V_{IN} is equal to the power supply voltage Vdd minus Vdata (V_{IN}=Vdd−Vdata, where Vdata is a grayscale display voltage corresponding to the pixel circuit 10), but not limited thereto), in the light enable phase, the impact of the power supply voltage Vdd on the driving current I_{OLED} flowing through the OLED 101 is effectively reduced/mitigated/released in response to the data voltage V_{IN} related to the power supply voltage Vdd (i.e., V_{IN}=Vdd−Vdata). In other words, the driving current I_{OLED} flowing through the OLED 101 is not related to the threshold voltage Vₜₕ(T1) of the driving transistor T1 and is less (or even not) related to the power supply voltage Vdd.

The power unit 105 includes a power conduction transistor T2. The data storage unit 109 further includes a writing transistor T3, a collection transistor T4, and a reset transistor T5. The light-emitting control unit 111 includes a light-emitting control transistor T6.

In the present exemplary embodiment, the driving transistor T1, the power conduction transistor T2, the writing transistor T3, the collection transistor T4, the reset transistor T5, and the light-emitting control transistor T6 are all P-type transistors (for example, P-type thin-film-transistors (TFT)). Besides, an OLED display panel adopting the OLED pixel circuit 10 illustrated in FIG. 2 may be fabricated through a low-temperature polysilicon (LTPS) TFT fabrication process, an amorphous silicon (a-Si) TFT fabrication process, or an a-IGZO TFT fabrication process. However, the invention is not limited thereto.

Additionally, in the circuit configuration (6T+1C) of the OLED pixel circuit 10 illustrated in FIG. 2, the gate of the driving transistor T1 is coupled to the first end of the storage capacitor Cst, and the second end of the storage capacitor Cst is (directly) coupled to the reference potential Vss. The source of the power conduction transistor T2 receives the power supply voltage Vdd, the gate of the power conduction transistor T2 receives the light enable signal LE, and the drain of the power conduction transistor T2 is coupled to the source of the driving transistor T1.

The gate of the writing transistor T3 receives the write scan signal S[n], the source of the writing transistor T3 receives the data voltage V_{IN} (for example, V_{IN}=Vdd−Vdata), and the drain of the writing transistor T3 is coupled to the source of the driving transistor T1 and the drain of the power conduction transistor T2. The gate of the collection transistor T4 receives the write scan signal S[n], the source of the collection transistor T4 is coupled to the gate of the driving transistor T1 and the first end of the storage capacitor Cst, and the drain of the collection transistor T4 is coupled to the drain of the driving transistor T1.

The gate and the source of the reset transistor T5 are coupled with each other for receiving the reset scan signal S[n−1], and the drain of the reset transistor T5 is coupled to the gate of the driving transistor T1, the source of the collection transistor T4, and the first end of the storage capacitor Cst. The gate of the light-emitting control transistor T6 receives the light enable signal LE, and the source of the light-emitting control transistor T6 is coupled to the drains of the driving transistor T1 and the collection transistor T4. The anode of the OLED 101 is coupled to the drain of the light-emitting control transistor T6, and the cathode of the OLED 101 is coupled to the reference potential Vss. In following examples, the reference potential Vss is assumed to be a zero potential (i.e., the ground potential) for the convenience of description. However, the invention is not limited thereto.

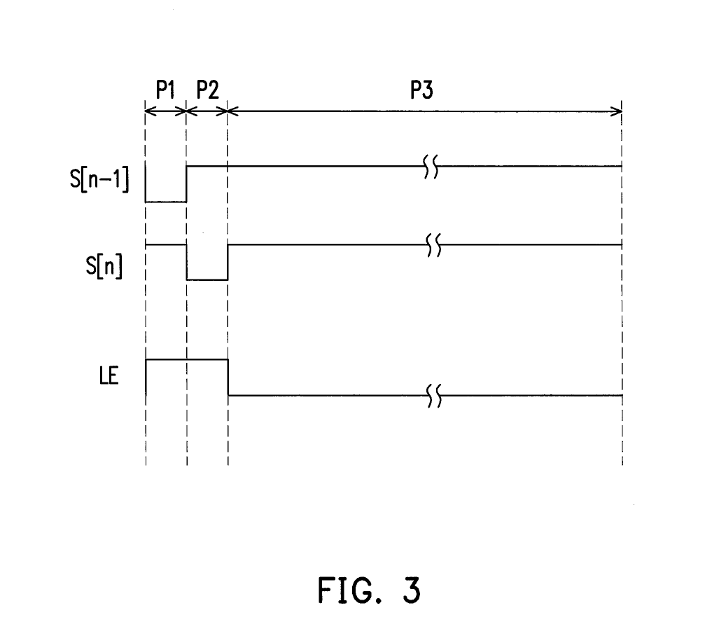

Moreover, in the operating procedure of the OLED pixel circuit 10 illustrated in FIG. 2, the light-emitting component driving circuit 103 (i.e., an OLED driving circuit) sequentially enters the reset phase, the data-writing phase, and the light enable phase (denoted as P1, P2, and P3 in FIG. 3). In the present exemplary embodiment, in the reset phase P1, only the reset scan signal S[n−1] is enabled. In the data-writing phase P2, only the write scan signal S[n] is enabled. In the light enable phase P3, only the light enable signal LE is enabled.

In other words, in the reset phase P1, the reset scan signal S[n−1] is enabled, while the write scan signal S[n] and the light enable signal LE are disabled. In the data-writing phase P2, the write scan signal S[n] is enabled, while the reset scan signal S[n−1] and the light enable signal LE are disabled. In the light enable phase P3, the light enable signal LE is enabled, while the reset scan signal S[n−1] and the write scan signal S[n] are disabled. However, the high and low levels (VH, VL) of the reset scan signal S[n−1], the write scan signal S[n], and the light enable signal LE can be determined according to the actual design/application requirement.

It should be mentioned herein that because the driving transistor T1, the power conduction transistor T2, the writing transistor T3, the collection transistor T4, the reset transistor T5, and the light-emitting control transistor T6 in the OLED pixel circuit 10 illustrated in FIG. 2 are all P-type, the driving transistor T1, the power conduction transistor T2, the writing transistor T3, the collection transistor T4, the reset transistor T5, and the light-emitting control transistor T6 are low active. Thus, foregoing expressions about the enabling of the reset scan signal S[n−1], the write scan signal S[n], and the light enable signal LE means that the reset scan signal S[n−1], the write scan signal S[n], and the light enable signal LE are at a low level.

Accordingly, in the reset phase P1, because only the reset scan signal S[n−1] is enabled, the voltage on the gate of the driving transistor T1 is equal to the low level (VL_{S[n-1]}) of the reset scan signal S[n−1] minus the Vₜₕ(T5) (i.e., VL_{S[n-1]}−Vₜₕ(T5)) in response to the turned-on of the diode-connected reset transistor T5. Herein Vₜₕ(T5) is the threshold voltage of the reset transistor T5. Meanwhile, because the light enable signal LE is disabled, the power conduction transistor T2 and the light-emitting control transistor T6 are in a turned-off state so that sudden brightening of the OLED 101 is prevented and accordingly the contrast of a displayed image is maintained. In addition, because the write scan signal S[n] is disabled, the writing transistor T3 and the collection transistor T4 are also in a turned-off state.

Then, in the data-writing phase P2, because only the write scan signal S[n] is enabled, the writing transistor T3 and the collection transistor T4 are both in a turned-on state. In this case, the data voltage V_{IN} (=Vdd−Vdata) is conducted to the storage capacitor Cst via the writing transistor T3 and the diode-connected driving transistor T1 and collection transistor T4, which makes the voltage on the gate of the driving transistor T1 equal to Vdd−Vdata−Vₜₕ(T1). Meanwhile, in the data-writing phase P2, because the reset scan signal S[n−1] and the light enable signal LE are disabled, the reset transistor T5, the power conduction transistor T2, and the light-emitting control transistor T6 are all in the turned-off state. Accordingly, the OLED 101 won't suddenly brighten up in the data-writing phase P2.

Eventually, in the light enable phase P3, because only the light enable signal LE is enabled, the writing transistor T3, the collection transistor T4, and the reset transistor T5 are in the turned-off state, and the driving transistor T1, the power conduction transistor T2, and the light-emitting control transistor T6 are in the turned-on state. Accordingly, the driving transistor T1 generates the driving current I_{OLED} flowing through the OLED 101 in response to the cross-voltage of the storage capacitor Cst. The driving current I_{OLED} is completely unaffected by the threshold voltage Vₜₕ(T1) of the driving transistor T1, and the impact of the power supply voltage Vdd (which changes in response to IR drop) on the driving current I_{OLED} is also effectively mitigated.

To be specific, in the circuit configuration illustrated in FIG. 2, the driving current I_{OLED} generated by the driving transistor T1 in the light enable phase P3 can be expressed with following expression 1:

$${I}_{OLED} = \frac{1}{2} K \times {( Vsg - {V}_{th} ( T 1 ) )}^{2} , \qquad 1$$

In foregoing expression 1, K is a current constant related to the driving transistor T1.

In addition, the source-gate voltage Vsg of the driving transistor T1 is known. Namely, the voltage Vs on the source of the driving transistor T1 is equal to the power supply voltage Vdd (i.e., Vs=Vdd). Assuming that the reference potential Vss is zero, the voltage Vg on the gate of the driving transistor T1 is equal to Vdd−Vdata−Vₜₕ(T1) (i.e., Vg=Vdd−Vdata−Vₜₕ(T1)). Besides, Vsg=Vs−Vg=Vdd−(Vdd−Vdata−Vₜₕ(T1)).

Obviously, in the OLED pixel circuit 10 illustrated in FIG. 2, the voltage Vs on the source of the driving transistor T1 is equal to the highest level of the power supply voltage Vdd (may be denoted as VH_{Vdd}). In addition, in the pixel circuit 10 illustrated in FIG. 2, the voltage Vg on the gate of the driving transistor T1 is equal to Vdd−Vdata−Vₜₕ(T1). Herein “Vdd” is the high voltage level related to the power supply voltage Vdd in the data voltage V_{IN}, which may be denoted as VH_{VIN}.

Because the power supply voltage Vdd and the data voltage V_{IN} (Vdd-Vdata) have different circuit layouts, substantially VH_{Vdd}−VH_{VIN} is not equal to zero (ideally should be equal to zero). Accordingly, the driving current I_{OLED} generated by the driving transistor T1 in FIG. 2 may be affected when the power supply voltage Vdd changes in response to IR drop.

However, if the impact of IR drop on the highest level VH_{Vdd} of the power supply voltage Vdd is made substantially equal to the impact of the RC loading effect on the high voltage level VH_{VIN} related to the power supply voltage Vdd in the data voltage V_{IN} (Vdd−Vdata) (i.e., VH_{Vdd}−VH_{VIN} is substantially zero, but not limited thereto) through an appropriate layout design, the impact of the power supply voltage Vdd (which changes in response to IR drop) on the driving current I_{OLED} generated by the driving transistor T1 in FIG. 2 can be effectively mitigated.

In following description, it is assumed that VH_{Vdd}≈VH_{VIN}. When the OLED pixel circuit 10 in FIG. 2 is in the light enable phase P3, there is following expression 2 by bringing the source-gate voltage Vsg of the driving transistor T1 into foregoing expression 1:

$${I}_{OLED} = \frac{1}{2} K \times {[ {VH}_{Vdd} - ( {VH}_{VIN} - Vdata - {V}_{th} ( T 1 ) ) - {V}_{th} ( T 1 ) ]}^{2} , \qquad 2$$

and the expression 2 can be further simplified into following expression 3:

$${I}_{OLED} = \frac{1}{2} K \times {[ ( {VH}_{Vdd} - {VH}_{VIN} ) + Vdata ]}^{2} . \qquad 3$$

However, if the highest level VH_{Vdd} of the power supply voltage Vdd and the high voltage level VH_{VIN} related to the power supply voltage Vdd in the data voltage V_{IN} (Vdd−Vdata) are designed to be substantially equal to each other (i.e., VH_{Vdd}=VH_{VIN}), foregoing expression 3 can be further simplified into following expression 4:

$${I}_{OLED} = \frac{1}{2} K \times {( Vdata )}^{2} . \qquad 4$$

Thereby, the driving transistor T1 can generate a driving current I_{OLED} substantially unaffected by the threshold voltage Vₜₕ(T1) of the driving transistor T1 in the light enable phase P3, and the impact of the power supply voltage Vdd (which changes in response to IR drop) on the driving current I_{OLED} is also effectively mitigated (if VH_{Vdd} is not equal to VH_{VIN}). Moreover, the driving current I_{OLED} may even be completely unaffected by the power supply voltage Vdd which changes in response to IR drop (if VH_{Vdd} is equal to VH_{VIN}).

In other words, the expression 4 makes it obvious that in the circuit configuration illustrated in FIG. 2, the driving current I_{OLED} flowing through the OLED 101 is substantially not related to the power supply voltage Vdd and the threshold voltage Vₜₕ(T1) of the driving transistor T1 and is only related to Vdata in the data voltage V_{IN}. Accordingly, any variation on the threshold voltage of a TFT caused by process factors can be compensated, and any change of the power supply voltage Vdd caused by IR drop can be compensated at the same time.

If an OLED pixel circuit (for example, a conventional 2T+1C pixel circuit) in which the impact of IR drop on the power supply voltage Vdd is not compensated at all is simulated, when the power supply voltage Vdd is reduced for 1V, the driving current I_{OLED} flowing through the OLED 101 may be reduced 50%. However, if the OLED pixel circuit illustrated in FIG. 2 is simulated, when the power supply voltage Vdd is reduced for 1V, the driving current I_{OLED} flowing through the OLED 101 may be reduced 6% (if VH_{Vdd} is not equal to VH_{VIN}) or may even be completely unaffected (if VH_{Vdd} is equal to VH_{VIN}).

Accordingly, the OLED pixel circuit 10 disclosed in foregoing exemplary embodiment has a circuit configuration of 6T1C (i.e., 6 TFTs and 1 capacitor, as shown in FIG. 2). When signals having appropriate operating waveforms (as shown in FIG. 3) are supplied, the OLED pixel circuit 10 keeps the driving current I_{OLED} flowing through the OLED 101 unchanged when the Vth shift of the TFT T1 for driving the OLED 101 changes and eases the impact of the power supply voltage Vdd on the current. Thereby, the luminance uniformity of an OLED display adopting the OLED pixel circuit 10 is greatly improved.

Moreover, any OLED display panel adopting an OLED pixel circuit 10 described in foregoing exemplary embodiments and an OLED display thereof are within the scope of the invention.

Furthermore, even though all the transistors of the OLED pixel circuit in each exemplary embodiment described above are P-type transistors, the invention is not limited thereto. In other words, one person having ordinary skill in the art can implement the OLED pixel circuit disclosed in the invention by using N-type transistors based on the descriptions of foregoing exemplary embodiments, and such varied embodiments are also within the scope of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

Additionally, any embodiment of claim of the invention is not expected to achieve all aspects, advantages, or characteristics disclosed by the invention. Moreover, the abstract and title of the disclosure are intended for patent search but not intended to limit the scope of the invention.

What is claimed is:

1. A light-emitting component driving circuit, comprising:
a power unit, receiving a power supply voltage, and conducting the power supply voltage in response to a light enable signal in a light enable phase;
a driving unit, coupled between the power unit and a light-emitting component, comprising a driving transistor, and controlling a driving current flowing through the light-emitting component in the light enable phase;
a data storage unit, comprising a storage capacitor coupled between the driving transistor and a reference potential, and storing a data voltage and a threshold voltage of the driving transistor through the storage capacitor in response to a write scan signal in a data-writing phase; and
a light-emitting control unit, coupled between the driving unit and the light-emitting component, and conducting the driving current from the driving unit to the light-emitting component in response to the light enable signal in the light enable phase,
wherein in the light enable phase, the driving unit generates the driving current flowing through the light-emitting component in response to a cross-voltage of the storage capacitor, and the driving current is not affected by the threshold voltage of the driving transistor.

2. The light-emitting component driving circuit according to claim 1, wherein
the data voltage is related to the power supply voltage; and
in the light enable phase, an impact of the power supply voltage on the driving current is mitigated in response to the data voltage related to the power supply voltage.

3. The light-emitting component driving circuit according to claim 2, wherein the power unit comprises:
a power conduction transistor, having a source for receiving the power supply voltage and a gate for receiving the light enable signal,
wherein a source of the driving transistor is coupled to a drain of the power conduction transistor, and a gate of the driving transistor is coupled to a first end of the storage capacitor,
wherein a second end of the storage capacitor is coupled to the reference potential.

4. The light-emitting component driving circuit according to claim 3, wherein the data storage unit further comprises:
a writing transistor, having a gate for receiving the write scan signal, a source for receiving the data voltage, and a drain coupled to the drain of the power conduction transistor and the source of the driving transistor; and
a collection transistor, having a gate for receiving the write scan signal, a source coupled to the gate of the driving transistor and the first end of the storage capacitor, and a drain coupled to a drain of the driving transistor.

5. The light-emitting component driving circuit according to claim 4, wherein the data storage unit further initializes the storage capacitor in response to a reset scan signal in a reset phase, and the data storage unit further comprises:
a reset transistor, having a gate and a source coupled with each other for receiving the reset scan signal and a drain coupled to the gate of the driving transistor, the source of the collection transistor, and the first end of the storage capacitor.

6. The light-emitting component driving circuit according to claim 5, wherein the light-emitting control unit comprises:
a light-emitting control transistor, having a gate for receiving the light enable signal and a source coupled to the drains of the driving transistor and the collection transistor,
wherein a first terminal of the light-emitting component is coupled to a drain of the light-emitting control transistor, and a second terminal of the light-emitting component is coupled to the reference potential,
wherein the driving transistor, the power conduction transistor, the writing transistor, the collection transistor, the reset transistor, and the light-emitting control transistor are all P-type transistors,
wherein the light-emitting component is an organic light-emitting diode (OLED), the first terminal of the light-emitting component is an anode of the OLED, and the second terminal of the light-emitting component is a cathode of the OLED.

7. The light-emitting component driving circuit according to claim 6, wherein the light-emitting component driving circuit is an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

8. A pixel circuit, comprising:
a light-emitting component, emitting light in response to a driving current in a light enable phase;
a power unit, receiving a power supply voltage, and conducting the power supply voltage in response to a light enable signal in the light enable phase;
a driving unit, coupled between the power unit and the light-emitting component, comprising a driving transistor, and controlling the driving current flowing through the light-emitting component in the light enable phase;
a data storage unit, comprising a storage capacitor coupled between the driving transistor and a reference potential, and storing a data voltage and a threshold voltage of the driving transistor through the storage capacitor in response to a write scan signal in a data-writing phase; and
a light-emitting control unit, coupled between the driving unit and the light-emitting component, and conducting the driving current from the driving unit to the light-emitting component in response to the light enable signal in the light enable phase,
wherein in the light enable phase, the driving unit generates the driving current flowing through the light-emitting component in response to a cross-voltage of the storage capacitor, and the driving current is not affected by the threshold voltage of the driving transistor.

9. The pixel circuit according to claim 8, wherein
the data voltage is related to the power supply voltage; and
in the light enable phase, an impact of the power supply voltage on the driving current is mitigated in response to the data voltage related to the power supply voltage.

10. The pixel circuit according to claim 9, wherein the power unit comprises:
a power conduction transistor, having a source for receiving the power supply voltage and a gate for receiving the light enable signal,
wherein a source of the driving transistor is coupled to a drain of the power conduction transistor, and a gate of the driving transistor is coupled to a first end of the storage capacitor,
wherein a second end of the storage capacitor is coupled to the reference potential.

11. The pixel circuit according to claim 10, wherein the data storage unit further comprises:
a writing transistor, having a gate for receiving the write scan signal, a source for receiving the data voltage, and a drain coupled to the drain of the power conduction transistor and the source of the driving transistor; and
a collection transistor, having a gate for receiving the write scan signal, a source coupled to the gate of the driving transistor and the first end of the storage capacitor, and a drain coupled to a drain of the driving transistor.

12. The pixel circuit according to claim 11, wherein the data storage unit further initializes the storage capacitor in response to a reset scan signal in a reset phase, and the data storage unit further comprises:
a reset transistor, having a gate and a source coupled with each other for receiving the reset scan signal and a drain coupled to the gate of the driving transistor, the source of the collection transistor, and the first end of the storage capacitor.

13. The pixel circuit according to claim 12, wherein the light-emitting control unit comprises:
a light-emitting control transistor, having a gate for receiving the light enable signal and a source coupled to the drains of the driving transistor and the collection transistor,
wherein a first terminal of the light-emitting component is coupled to a drain of the light-emitting control transistor, and a second terminal of the light-emitting component is coupled to the reference potential,
wherein the driving transistor, the power conduction transistor, the writing transistor, the collection transistor, the reset transistor, and the light-emitting control transistor are all P-type transistors,
wherein the light-emitting component is an OLED, the first terminal of the light-emitting component is an anode of the OLED, and the second terminal of the light-emitting component is a cathode of the OLED,
wherein the pixel circuit is an OLED pixel circuit.

14. The pixel circuit according to claim 13, wherein the power unit, the driving unit, the data storage unit, and the light-emitting control unit form an OLED driving circuit, and the OLED driving circuit sequentially enters the reset phase, the data-writing phase, and the light enable phase,
wherein in the reset phase, the reset scan signal is enabled, and the write scan signal and the light enable signal are disabled,
wherein in the data-writing phase, the write scan signal is enabled, and the reset scan signal and the light enable signal are disabled,
wherein in the light enable phase, the light enable signal is enabled, and the reset scan signal and the write scan signal are disabled.

15. An OLED display panel comprising the pixel circuit as claimed in claim 13.

16. An OLED display comprising the OLED display panel as claimed in claim 15.

17. A light-emitting component driving circuit, comprising:
a power unit, receiving a power supply voltage, and conducting the power supply voltage in response to a light enable signal in a light enable phase;
a driving unit, coupled between the power unit and a light-emitting component, comprising a driving transistor, and controlling a driving current flowing through the light-emitting component in the light enable phase;
a data storage unit, comprising a storage capacitor coupled between the driving transistor and a reference potential, and storing a data voltage and a threshold voltage of the driving transistor through the storage capacitor in response to a write scan signal in a data-writing phase; and
a light-emitting control unit, coupled between the driving unit and the light-emitting component, and conducting the driving current from the driving unit to the light-emitting component in response to the light enable signal in the light enable phase,
wherein in the light enable phase, the driving unit generates the driving current flowing through the light-emitting component in response to a cross-voltage of the storage capacitor, and the driving current is not affected by the threshold voltage of the driving transistor,
wherein the data voltage is related to the power supply voltage, and in the light enable phase, an impact of the power supply voltage on the driving current is mitigated in response to the data voltage related to the power supply voltage.
